(19) United States
(12) Patent Application Publication
(10) Pub. No.: US 2019/0293192 A1
(43) Pub. Date: Sep. 26, 2019

(54) Cushioned Check Valve

(71) Applicant: Kennedy Valve Company, Elmira, NY (US)

(72) Inventor: Paul Kennedy, Horseheads, NY (US)

(21) Appl. No.: 15/933,950

(22) Filed: Mar. 23, 2018

(51) Int. Cl. F16K 15/03; F16K 15/18

(52) U.S. Cl. CPC F16K 15/03; F16K 15/181

(57) ABSTRACT

A hinge pin for a check valve includes a shaft, a first end of the shaft, a second end of the shaft opposite the first end, and a first connection element on the shaft between the first end and the second end. The first connection element lockably connects to a valve disk assembly, the first end having a second connection element to connect to an oil-cushion arm, the second end having a third connection element to connect to a counterweight arm, the shaft being composed of maraging steel.

### BACKGROUND OF THE INVENTION

### Field of the Invention

This disclosure pertains to fluid check valves. More particularly, this disclosure pertains to valve hinge pins for fluid check valves.

### Description of Related Art

In some systems, check valves are used to prevent or retard retrograde fluid flow when pumping systems are turned off or valves are closed. Changes in pump status when a pump is turned off, and closing of the check valve in these systems, may cause significant hydraulic shock, particularly when large diameter pipes and large differences in elevation are involved.

Hydraulic shock, otherwise known as water hammer, can occur in a piping system as a result of a rapid change in momentum of a fluid in the piping system. For example, such a rapid change in fluid momentum can result when a valve in the piping system is abruptly closed and the fluid stops flowing. As flowing fluids generally have a constant density and mass, changes in fluid momentum result from, for example, changes in fluid flow velocity, a cessation of fluid flow, or a reversal of flow direction causing retrograde flow. When a valve in the system closes and fluid flow within the system abruptly stops, the change in fluid flow velocity causes a shockwave to form and propagate through the fluid and piping structures that carry the fluid. The shockwave may be characterized, physically and mathematically, as a transient high pressure pulse moving through the fluid flow system.

When the shockwave impacts valve gates and other solid structures, the energy carried by the high pressure of the shockwave is transferred to these solid structures. The shockwave pressure impacting piping and valve structures is undesirable, as it is a source of unwanted acoustic noise, vibration, and extreme pressure gradients that may cause significant mechanical stress on pipes, valves, and other fixtures. In some cases, valve structures, such as hinge pins, can undergo significant strain, reducing their life, or damaging them.

Because basic system design considerations may not always be adjusted to mitigate hydraulic shock, or are cost prohibitive, cushioned check valves have been developed that change the rate of check valve closing to mitigate hydraulic shock. In these cushioned check valves, fluid being pumped from a lower elevation to a higher elevation may stop flowing toward the higher elevation, and reverse direction toward the lower elevation as valves are closed, or pumps stop pumping, while a check valve closes.

For example, a check valve in-line in a lift station between a lower elevation and a higher elevation requires a certain amount of time to close when movement of fluid toward the higher elevation stops, and retrograde flow begins to carry a valve disk backward toward a valve seat until the check valve closes and stops the retrograde flow. The fluid being pumped may therefore develop significant retrograde flow velocity toward the lower elevation that causes hydraulic shock with a significant amount of energy and pressure when the valve disk ultimately closes, and the retrograde flow abruptly stops.

Shockwave mitigation using check valves has focused on forcing the check valve to close at a faster rate than would otherwise occur based on retrograde fluid flow alone forcing a valve disk backward against a valve seat. Ideally, if the valve disk can be made to close at the moment flow stops, and before retrograde flow through the check valve begins, no hydraulic shock would occur. In actual practice, this ideal timing of the check valve closing is not always achievable.

If the rate at which a check valve closes is increased, the faster valve disk closing rate shortens the time retrograde fluid flow has to accelerate toward the closing check valve, and decreases retrograde flow velocity at the moment of check valve closure. Thus, rapid valve closing rates may significantly reduce shockwave energy and pressure, and mitigate hydraulic shock.

In some check valve constructions, counter-weights are used to accelerate the rate at which a valve disk closes, reducing retrograde flow velocity and shockwave energy and pressure.

In some check valve constructions, acceleration of the valve disk closure rate may also involve components, such as actuators or complex valve seat orientations, that interfere with the fluid flow path through the check valve, and thus reduce over-all flow rates through check valves of a given diameter.

The pressure of fluid against the valve disk, the hydraulic shock, and/or various potential forces to move the valve disk translate into strain and wear on a hinge pin upon which the valve disk rotates to swing the valve disk to an open or closed position.

### SUMMARY OF THE INVENTION

According to a first embodiment, a hinge pin for a check valve includes a shaft, a first end of the shaft, a second end of the shaft opposite the first end, and a first connection element on the shaft between the first end and the second end. The first connection element lockably connects to a valve disk assembly, the first end having a second connection element to connect to an oil-cushion arm, the second end having a third connection element to connect to a counterweight arm, and the shaft being composed of maraging steel.

According to a second embodiment, a check valve includes a valve body and a check valve closing assembly. The valve body has an inlet, an outlet, and a flow channel between the inlet and the outlet. The check valve closing assembly is in the flow channel of the valve body, and the check valve closing assembly includes the hinge pin of the first embodiment and a valve disk assembly. The hinge pin extends through the valve body and lockably connects to the valve disk assembly. The valve disk assembly is movable between an open position permitting a fluid to flow from the inlet of the valve body toward the outlet of the valve body, and a closed position blocking the fluid flow from the outlet toward the inlet of the valve body.

### BRIEF DESCRIPTION OF THE DRAWINGS

FIG. 1 shows a check valve embodiment during steady state flow of a fluid from the inlet to the outlet of the check valve.

FIG. 2 shows the check valve of FIG. 1 when a retrograde high pressure pulse enters the check valve moving from the outlet toward the inlet of the cushioned check valve.

FIG. 3 shows an isometric view of a check valve, according to one embodiment.

FIG. 4 shows a cross section of the check valve of FIG. 3.

FIG. 5 shows an isometric view of a hinge pin for a check valve, according to one embodiment.

FIG. 6 shows a front view of the hinge pin of FIG. 5.

FIG. 7 shows a first side view of the hinge pin of FIG. 5.

FIG. 8 shows a second side view of the hinge pin of FIG. 5.

### DETAILED DESCRIPTION OF THE INVENTION

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner.” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As discussed above, this disclosure pertains to fluid check valves, and more particularly, to a hinge pin for fluid check valves. The hinge pin has a stronger tensile strength than conventional hinge pins, such that it can be made smaller and/or it can withstand greater force, shock, or wear.

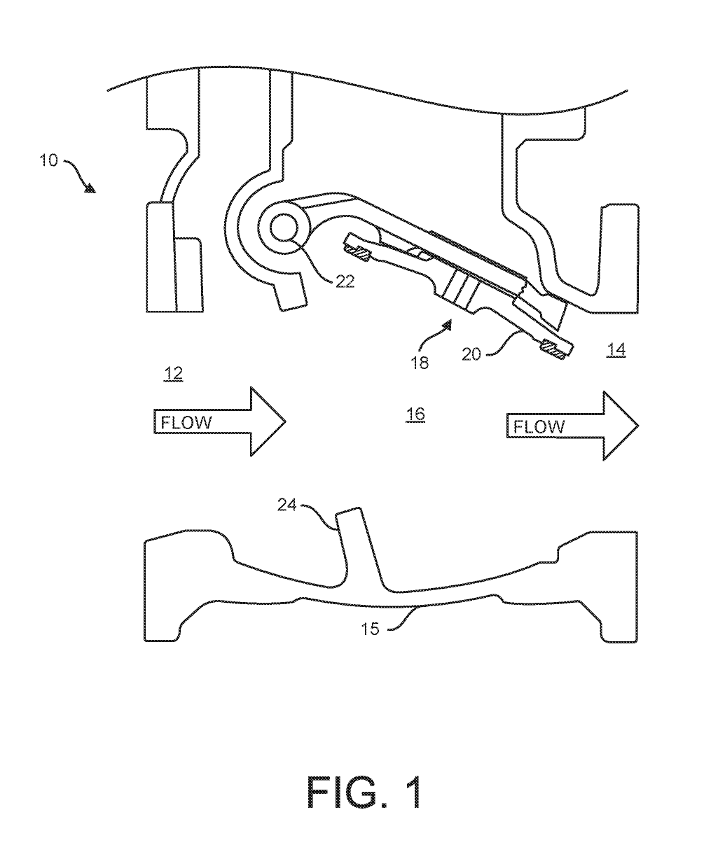

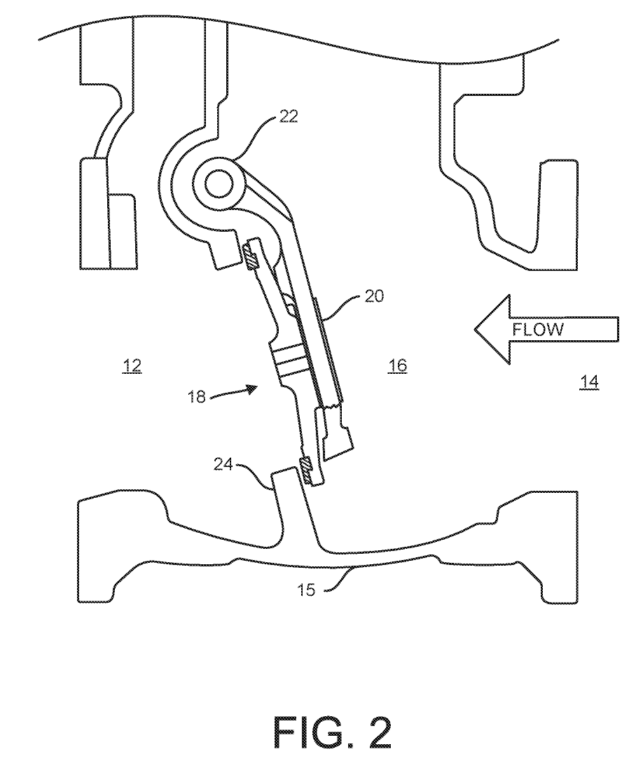

FIG. 1 shows a cross section of a portion of a check valve 10 during steady state flow of a fluid from an inlet 12 to an outlet 14 through a flow channel 16 of the check valve 10. The check valve 10 has a body 15 defining the fluid inlet 12, the fluid outlet 14, and the flow channel 16, which is between and fluidly connected to the fluid inlet 12 and the fluid outlet 14. A check valve closing member 18 allows fluid flow in one direction and blocks fluid flow in the other direction. The valve closing member 18 is here shown as a swing-type check valve in which a valve disk assembly 20 swings and rotates on a hinge pin 22, so that the valve disk assembly 20 may swing away from a valve seat 24 and out of the flow channel 16 between the inlet 12 and the outlet 14 to allow flow when fluid flow is pressurized from the inlet 12 toward the outlet 14, as shown in FIG. 1. As is customary with check valves, when fluid flow reverses direction and becomes retrograde, with fluid flow moving from the outlet 14 toward the inlet 12, the retrograde fluid flow carries the valve disk assembly 20 back toward the valve seat 24, stopping the retrograde fluid flow. FIG. 2 shows the check valve 10 in the closed position when a retrograde high pressure pulse enters the check valve 10 moving from the outlet 14 toward the inlet 12 of the check valve 10. The retrograde high pressure pulse can add a significant amount of force or shock to the hinge pin 22 where the valve disk assembly connects to the hinge pin 22. Any impact of the closing member 18 against the valve seat 24 can also result in shock to the hinge pin 22.

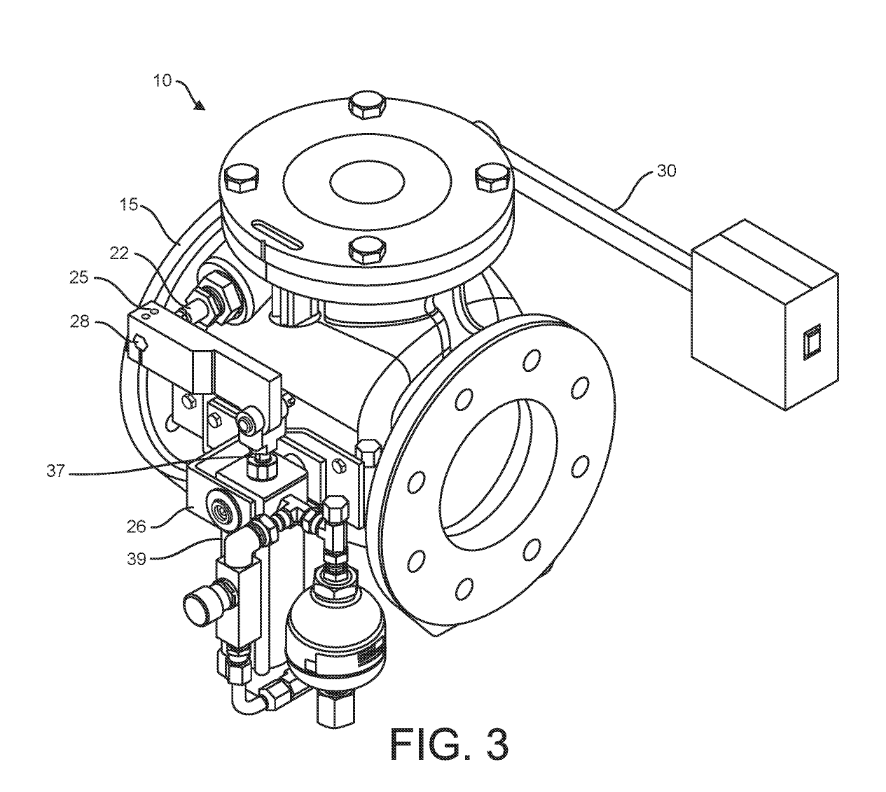

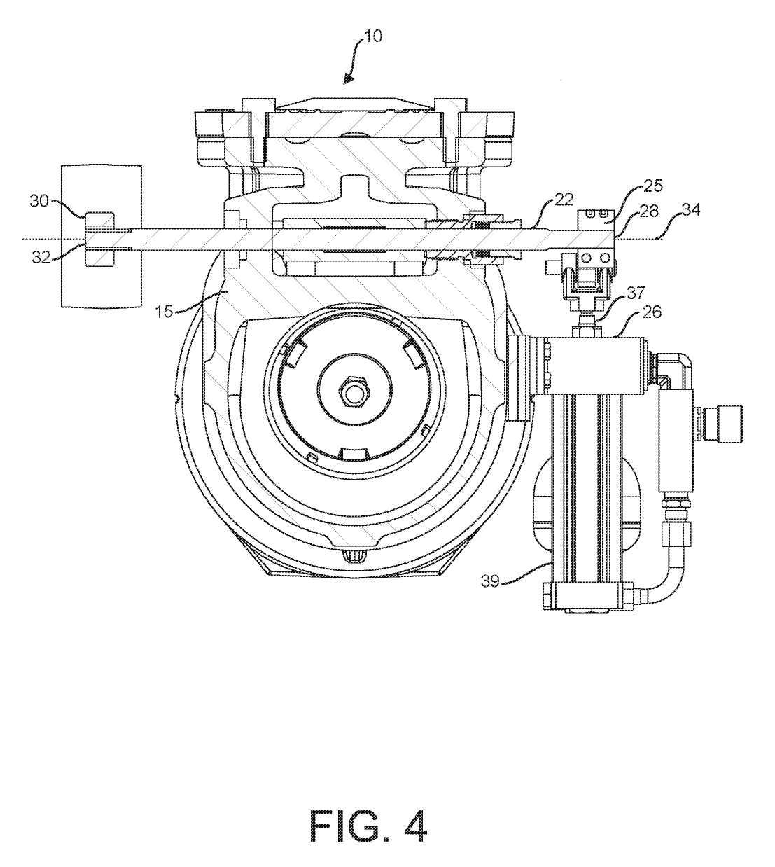

FIG. 3 shows an isometric view of the check valve 10, and FIG. 4 shows a cross section of the check valve 10 through the hinge pin 22. Referring to FIGS. 1-4, the hinge pin 22 can be extended through the valve body 15 and can be coupled to an oil-cushion arm 25 of an oil-cushion assembly 26 at a first end 28 of the hinge pin 22, and to a counterweight arm 30 at a second end 32 of the hinge pin 22. The oil-cushion assembly 26 offsets some of the closing force of the retrograde high pressure pulse acting on the closing member 18, and the counterweight arm 30 balances against the weight of the closing member 18 to balance the closing member 18 between the open position and the closed position, or to bias the closing member 18 as desired toward the open position or the closed position.

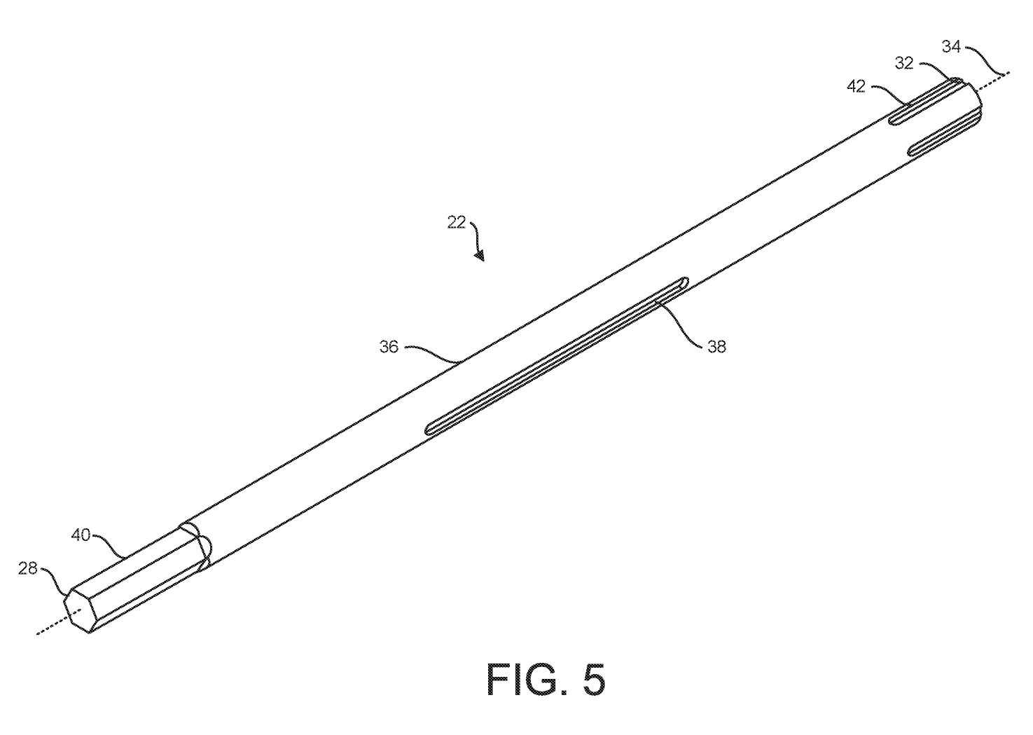

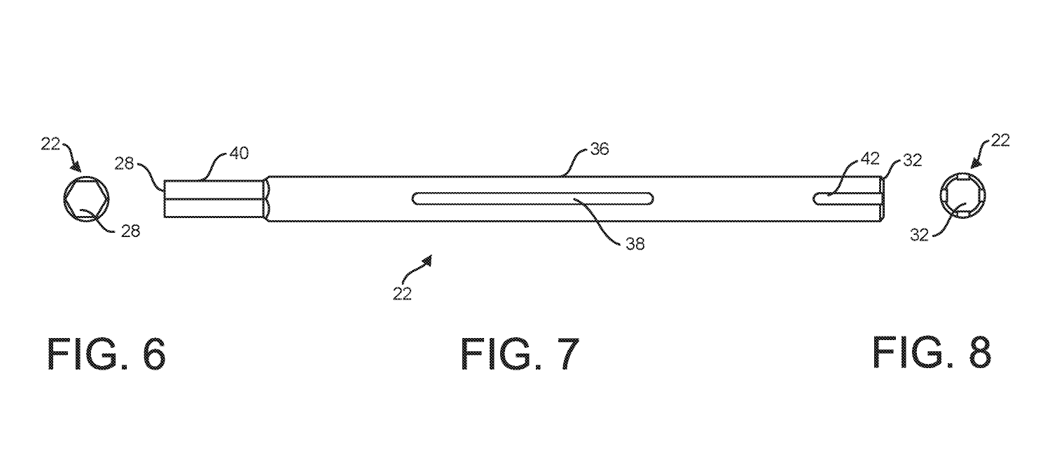

FIG. 5 shows an isometric view of the hinge pin 22, while FIG. 6 shows a front view of the hinge pin 22, FIG. 7 shows a first side view of the hinge pin 22, and FIG. 8 shows a second side view of the hinge pin 22. The hinge pin 22 can be part of the check valve closing member 18 including the valve disk assembly 20 attached to the hinge pin 22, such that the hinge pin 22 rotates about a hinge pin center axis or rotational axis 34, and the valve closing member 18 also rotates or revolves around the hinge pin rotational axis 34.

The hinge pin 22 has a shaft 36 extending between the first end 28 and the second end 32. The shaft 36 is shown to be straight and generally cylindrical, with specific other features altering the cylindrical shape in specific locations along the shaft. For example, the hinge pin 22 can have a first connection element 38 on the shaft 36 where the valve closing member 18 can attach. While the first connection element 38 is shown in the figures in a particular manner, it should be noted that the first connection element 38 can be any now-known or future-developed structure by which the valve disk assembly 20 can attach and lock to the shaft 36. For example, the first connection element 38 can be, but is not limited to, a slot, a channel, a groove, a clamping element, one or more flat surfaces, a bolt hole, or an internally threaded hole. In the embodiment of the hinge pin 22 illustrated in the figures, the first connection element 38 is in a middle section of the shaft 36 and includes a flat clamping section to which the valve disk assembly 20 can clamp to prevent rotation of the valve disk assembly 20 relative to the hinge pin 22. It should be noted that the shaft 36, while shown as straight and generally cylindrical, is not limited to being straight or cylindrical.

The first end 28 of the hinge pin 22 has a second connection element 40 to connect to the oil-cushion arm 25. Again, while the first end 28 is shown in the figures in a particular manner, it should be noted that the second connection element 40 can be any now-known or future-developed structure by which the counterweight arm 30 can attach and lock to the first end 28 of the hinge pin 22. For example, the second connection element 40 can be, but is not limited to, a slot, a channel, a groove, a clamping element, one or more flat surfaces, a bolt hole, an internally threaded hole, and external threads. In the embodiment of the hinge pin 22 illustrated in the figures, the second connection element 40 includes a hexagonal end, or five flat surfaces upon which the counterweight arm 30 can clamp or lock fit to prevent rotation of the oil-cushion assembly 26 relative to the hinge pin 22.

The second end 32 of the hinge pin 22 has a third connection element 42 to connect to the counterweight arm 30. Again, while the second end 32 is shown in the figures in a particular manner, it should be noted that the third connection element 42 can be any now-known or future-developed structure by which the counterweight arm 30 can attach and lock to the second end 32 of the hinge pin 22. For example, the third connection element 42 can be, but is not limited to, a slot, a channel, a groove, a clamping element, one or more flat surfaces, a bolt hole, an internally threaded hole, and external threads. In the embodiment of the hinge pin 22 illustrated in the figures, the third connection element 42 includes four grooves that fit into a congruently shaped hole in the counterweight arm 30, to prevent rotation of the counterweight arm 30 relative to the hinge pin 22.

Referring again to FIG. 3 and FIG. 4, embodiments without the oil-cushion assembly 26 are conceived, and other types of cushions, now-known or future-developed, can also be implemented in conjunction with the hinge pin 22. The oil-cushion assembly 26 includes the oil-cushion arm 25 to which the first end 28 of the hinge pin 22 can be fastened directly or indirectly. At a distance along the oil-cushion arm 34 from the connection to the hinge pin 22, the oil-cushion arm 25 is coupled to a shaft 37, which is driven by an actuator 39 to force revolutionary motion of the oil-cushion arm 25 around a rotational axis 40 of the hinge pin 22. The actuator 39 forces the hinge pin 22 to rotate, rapidly initiating closing of the valve closing member 18 before retrograde hydraulic pressure swells to slam the valve closing member 18. Any force of the retrograde high pressure pulse to close the closing member 18 and/or the force of the actuator to rapidly close the valve closing member 18 can stress and strain the hinge pin 22. Because the valve disk assembly 20 connects to the hinge pin in a separate axial location on the hinge pin 22 than the oil-cushion arm 25, the opposing forces of the actuator 39 and/or the retrograde pressure pulse against the inertia of the valve closing member 18 and/or against the stop force of the valve seat 24, act to twist the hinge pin 22.

To the second end 32 of the hinge pin 22, the counterweight arm 30 can be coupled directly or indirectly, such that rotation of the hinge pin 22 results in equivalent rotation of the counterweight arm 30 around the axis of connection of the counterweight arm 30 to the hinge pin 22. A counterweight 44 on a distal end of the counterweight arm 30 from the connection to the hinge pin 22 can act to bias the closing member 18 in an open or closed position, as desired, or can act to offset the weight of the closing member 18 to balance the closing member 18 between an open position and a closed position. The counterweight 44 and the weight of the closing member 18 can also add strain to the hinge pin 10.

The shaft 36 and ends 28, 32 of the hinge pin 22 can be manufactured from maraging steel, such as maraging steel specified by ASTM A 579 Grade 73. The use of stainless steel has been entrenched in the hydrant industry for its beneficial properties, such as its corrosion-resistance, which is particularly beneficial in a wet operating-environment. The benefits of manufacturing the hinge pint 22 from maraging steel are recognized herein, though. Maraging steel is a special class of low-carbon ultra-high-strength steel that derives its strength from precipitation of intermetallic compounds rather than from carbon. The principal alloying element is 15 to 25 percent by weight nickel. Secondary alloying elements, which include cobalt, molybdenum, and titanium, are added to produce the intermetallic precipitates. ASTM A 579 Grade 73 maraging steel is a medium carbon, low alloy, ultra-high strength 1000 Mpa steel primarily designed for high strength structural applications. This grade of maraging steel can be produced by a consumable electrode vacuum are re-melting process to provide cleanliness and an ingot structure, which in turn provides strong transverse mechanical properties.

Due to the structure and material, the hinge pin 22 has a tensile strength of at least 250.000 pounds per square inch, without becoming brittle. In some embodiments, the tensile strength can be at least 300.000 pounds per square inch. This strength enables the hinge pin 10 to withstand hydraulic shock, torsional strain, or other forces, with the hinge pin being a smaller size than typical hinge pins.

The hinge pin 10 can be coated, for example, with electroless nickel or tin flash plating, to deter corrosion, increase longevity, and reduce friction of the hinge pin 22.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A hinge pin for a check valve for a fluid flow system, the hinge pin comprising:
a shaft having a first end and a second end, the second end of the shaft opposite the first end; and
a first connection element on the shaft between the first end and the second end, the first connection element configured to lockably connect to a valve disk assembly,
the first end having a second connection element,
the second end having a third connection element configured to connect to a counterweight arm,
the shaft being composed of maraging steel, the maraging steel including 15 to 25 percent by weight nickel.

2. The hinge pin of claim 1, wherein the hinge pin has a tensile strength of at least 2.068427e+9 Pascals.

3. The hinge pin of claim 1, further comprising an electroless nickel and tin flash plating on the shaft.

4. The hinge pin of claim 1, wherein the second connection element is configured to connect to an oil-cushion arm.

5. The hinge pin of claim 1, wherein the second end has a third connection element configured to connect to a counterweight arm.

6. A check valve for a fluid flow system, comprising:
a valve body having an inlet, an outlet, and a flow channel between the inlet and the outlet; and
a check valve closing assembly in the flow channel of the valve body,
the check valve closing assembly including a hinge pin and a valve disk assembly, the hinge pin extending through the valve body, the hinge pin lockably connected to the valve disk assembly, the valve disk assembly movable between an open position permitting a fluid to flow from the inlet of the valve body toward the outlet of the valve body, and a closed position blocking the fluid flow from the outlet toward the inlet of the valve body, the hinge pin being composed of maraging steel.

7. The check valve of claim 6, wherein the valve disk assembly mates with a valve seat in the closed position.

8. The check valve of claim 6, wherein the hinge pin rotates relative to the valve body.

9. The check valve of claim 6, wherein the hinge pin is electroplated with nickel.

10. The check valve of claim 6, wherein the first end has a second connection element configured to connect to an oil-cushion arm.

11. The check valve of claim 6, wherein the second end has a third connection element configured to connect to a counterweight arm.

12. (canceled)

13. The hinge pin of claim 1, wherein secondary alloying elements of the maraging steel include at least one of cobalt, molybdenum, and titanium.

14. The check valve of claim 6, wherein the maraging steel includes 15 to 25 percent by weight nickel.

15. The check valve of claim 6, wherein secondary alloying elements of the maraging steel include at least one of cobalt, molybdenum, and titanium.

16. The hinge pin of claim 1, wherein the maraging steel meets ASTM A579 version 17a Grade 73 standards.

17. The hinge pin of claim 1, wherein the maraging steel includes 18 to 19 percent by weight nickel.

18. The check valve of claim 6, wherein the maraging steel meets ASTM A579 version 17a Grade 73 standards.

19. The check valve of claim 6, wherein the maraging steel includes 18 to 19 percent by weight nickel.
